(19) United States
(12) Patent Application Publication
(10) Pub. No.: US 2003/0029170 A1
(43) Pub. Date: Feb. 13, 2003

(54) Rhenlum reactor

(76) Inventor: Roger Rhenium, Chicago, IL (US)

Correspondence Address: ROGER RHENIUM, 5549 1/2 N. MAGNOLIA, CHICAGO, IL, 60640, US

(21) Appl. No.: 09/682,270

(22) Filed: Aug. 12, 2001

(51) Int. Cl. F02B 1/00

(52) U.S. Cl. 60/721

(57) ABSTRACT

An innovative way of producing propulsion by rotating a bent circular tube while mass is circulating through it. New in principle and function to any known propulsion concept.

### BRIEF DESCRIPTION OF DRAWINGS

FIG. 1-A The Tube

FIG. 1-B Cutout showing steel balls in tube

FIG. 1-C Motorized gear used to circulate steel balls in the tube

FIG. 2 Side view of tube

FIG. 3 View showing tube after being rotated 90 degrees

FIG. 4 View showing tube after being rotated 180 degrees on a different plane

FIG. 5 View showing tube after being rotated 270 degrees on another plane, Tube being rotated the final 360 degrees not shown

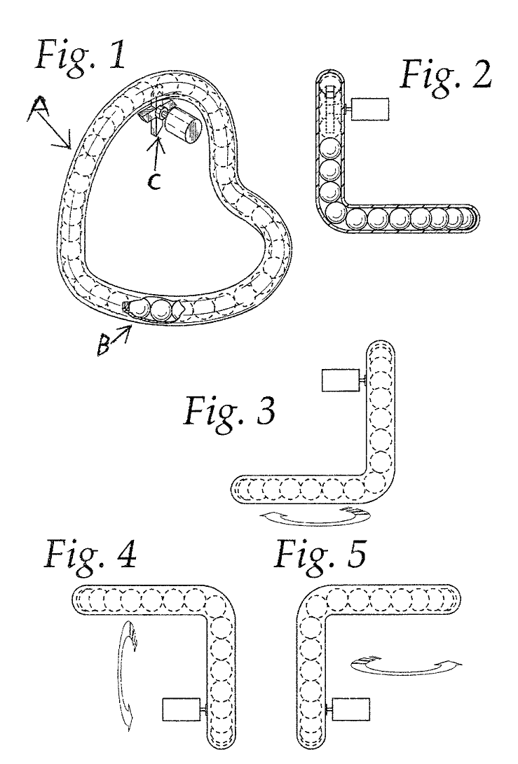

### DETAILED DESCRIPTION

A circular tube either metal or rigid in nature is constructed so half of tube is at a ninety degree angle with respect of other half of tube. The tube is completely filled with mass such as a liquid or metal balls that is/are capable of being circulated through tube, when this tube is rotated while mass inside of the tube is in a state of circulation, propulsion is created. Metal balls driven by a motorized gear are depicted in drawings as the circulating mass in tube, a different mass such as a liquid would use a different method of circulation without diminishing the principle or function of the tube, likewise different methods of rotating the tube itself either manually, mechanically or electrically may be employed without diminishing the principle or function of the tube. Propulsive force can be sustained by rotating this tube ninety degrees on one plane than counter rotating the tube ninety degrees on another plane on a continuous sequential basis.

1. What I claim as my invention is a circular tube constructed so half of tube is at a ninety degree angle with respect to the other half of the tube. Rotating this tube while mass is being circulated in it created propulsion.

2. I further claim that various methods of rotating this tube may be employed to achieve sustained propulsion without diminishing the principal or function of tube.

3. I further claim that various methods of circulating mass through this tube may be employed without diminishing the principal or function of tube.

4. I further claim a tube or solid metal bar constructed in the form of a closed circuit loop whereas half of this closed circuit loop is in a semi-circular formation and the other half is in a semi-circular formation, but perpendicular to the first half of circular loop. When mass is circulated through tube, or energy is propagated through bar by percussion and device is rotated while this is taking place propulsion is created.

5. I further claim a tube or solid metal bar constructed in the form of a closed circuit loop whereas half of this closed circuit loop is in a semi-circular formation and the other half is in a linear form, the tube or bar then looks like the letter “D”, when mass or energy is propagated through this device and device is rotated simultaneously propulsion is created.
